(19) United States
(12) Patent Application Publication
(10) Pub. No.: US 2026/0039056 A1
(43) Pub. Date: Feb. 5, 2026

(54) HOUSING FOR A CONNECTOR AS WELL AS CONNECTOR AND CONNECTION ASSEMBLY

(71) Applicant: TE Connectivity Solutions GmbH, Schaffhausen (CH)

(72) Inventors: Konrad Helmut ROTH, Bensheim (DE); Georg PUCKEL, Bensheim (DE); Andre MAIROSER, Bensheim (DE); Jurek REUTER, Bensheim (DE)

(21) Appl. No.: 19/286,404

(22) Filed: Jul. 31, 2025

(30) Foreign Application Priority Data
Jul. 31, 2024 (DE) 102024121804.5

(51) Int. Cl. H01R 13/627; H01R 43/26

(52) U.S. Cl. CPC H01R 13/6272; H01R 43/26

(57) ABSTRACT

A housing for a connector that can be plugged together with a mating connector along a plugging direction includes a latching element movable between a release position and a latched position for a releasable latching engagement with the mating connector, and that comprises a push-button section operated in a triggering direction. A cover element\covers the push-button section in the triggering direction, wherein an access channel is accessible from outside the housing for inserting a tool tip extends between the push-button section and the cover element. The accessibility of the push-button section is restricted by the cover element. The tool tip is inserted into the access channel to allow the push-button section to be operated only under controlled conditions.

### CROSS REFERENCE TO RELATED APPLICATIONS

This application claims the benefit of DE Application No. 102024121804.5, filed 31 Jul. 2024, the subject matter of which is herein incorporated by reference in its entirety.

### BACKGROUND OF THE INVENTION

The subject matter herein relates to a housing for a connector that can be plugged together with a mating connector along a plugging direction.

Connection assemblies are used for power and/or signal transmission purposes in many fields of technology. To prevent accidental or improper disconnection of the connection assembly due to vibrations or other external influences, releasable latching engagements are often employed to maintain the mated state of the connector and the mating connector.

Especially in high-voltage applications, accidental release of the latching engagement and subsequent disconnection of the connection assembly can cause material damage as well as physical injury.

A need remains for a connection assembly having safety and reliability.

### BRIEF DESCRIPTION OF THE INVENTION

In one embodiment, a housing is providing including a latching element that is configured to be movable between a release position and a latched position for a releasable latching engagement with the mating connector, and that comprises a push-button section that can be operated in a triggering direction, upon the operation of which the latching engagement is released, as well as a cover element that covers the push-button section at least partly in the triggering direction, wherein an access channel that is accessible from outside the housing for inserting a tool tip extends between the push-button section and the cover element.

The tool tip can be, in particular, a geometrically predetermined work tip of a predefined tool, for example, of a turnscrew or a screwdriver, respectively. In particular, the tool tip can be a blade tip for slotted screws. Operation of the push-button section can cause the latching element to move from the latched position to the release position, which in turn releases the latching engagement.

The subject matter herein is advantageous because the cover element restricts accessibility of the push-button section. The tool tip can be inserted into the access channel. This allows the push-button section to be operated only under controlled conditions.

However, it can prevent that the push-button section is accidentally operated with the finger or other body parts. Furthermore, damage to the push-button section can be prevented. This increases safety and reliability of connection assemblies in which the housing is employed.

The subject matter herein can be further improved by the following configurations which are advantageous by themselves and which may be combined with one another arbitrarily.

According to a first exemplary embodiment, the access channel can be configured to be accessible in the plugging direction and/or extend in a straight line along the plugging direction. This embodiment is particularly suitable for the use of elongate tool tips.

Furthermore, the housing can comprise a mating face side pointing in the plugging direction. The mating face side preferably has a shape that is complementary to the mating face of the mating connector and forms an interface, for example, according to an industry standard.

Furthermore, the housing can have a cable outlet side arranged in the plugging direction opposite the mating face side with respect to the housing. The cable outlet side preferably forms a point at which an electrical conductor, for example, a cable or wire, can exit the housing.

According to another possible embodiment, the access channel can be arranged on the cable outlet side and/or configured to be accessible from the cable outlet side. This configuration of the access channel allows for the latching engagement to be released from the cable outlet side and therefore “from behind” using the tool tip. When in the mated state, the connectors are typically easily accessible from their cable outlet side, since there must be space there for the aforementioned electrical conductors. Above all, the connector with the housing no longer needs to be accessible from the side, which makes it possible to place several connectors close together.

The triggering direction of the push-button section can be transverse, in particular perpendicular, to the plugging direction. Consequently, the cover element can cover the push-button section transversely, in particular perpendicularly to the plugging direction. In this case, the cover element covers the push-button section preferably from outside the housing. Furthermore, the cover element can form an abutment surface disposed opposite the push-button section to support the tool tip that is disposed between the push-button section and the cover element.

The abutment surface makes it easier to operate the push-button section with the tool tip and thereby move the latching element to the release position. That is, the tool tip can be applied against the abutment surface to lever the latching element to the release position. The abutment surface can form a pivot point from which the tool tip extends towards the push-button section and from which the remainder of the tool (for example, the tool shank and tool handle) faces away from the push-button section. Due to pivot motion of the tool handle, the tool tip can then be pressed onto the push-button section in the triggering direction. This operates the push-button section and releases the latching engagement.

The region between the push-button section and the cover element can form a tool holder for receiving the tool tip. In particular, the push-button section and the cover element form at least in sections the access channel, at the end of which the tool holder is formed. The cover element and the push-button section then jointly form the tool holder. The aforementioned abutment surface of the cover element can extend at least in sections parallel to the push-button section when the latching element is in the latched position. When the latching element is in the release position, the abutment surface can extend at an angle to the push-button section so that this region of the access channel, in particular the tool holder, is then at least wedge-shaped.

If sufficient pivot motion of the tool handle is not possible due to space constraints, a further embodiment can be used in which the access channel is configured to be non-rotationally symmetrical with respect to the plugging direction, at least in the region between the push-button section and the cover element. This means that a cross-section of this region of the access channel, in particular of the tool holder, perpendicular to the plugging direction is non-circular. For example, this region of the access channel, in particular of the tool holder, can have a rectangular or lens-shaped cross-section perpendicular to the plugging direction. This has the advantage that a flat non-rotationally symmetrical tool tip (for example, a slotted screwdriver) can be inserted into the tool holder and thereafter the tool holder can be spread open by rotating the tool tip about a longitudinal tool axis, thereby operating the push-button section in the triggering direction. In other words, the latching element can be levered to the release position by torsion of the tool tip.

Optionally, the region between the push-button section and the cover element, in particular the tool holder, is narrower than the thickness of the tool tip when the latching element is in the latched position. In other words, when the latching element is in the latched position, the spacing between the push-button section and the cover element is smaller than the thickness of the tool tip. For example, the push-button section can occupy the tool holder when the latching element is in the latched position. This means that the push-button section fills the tool holder such that the tool tip can be inserted there only if the push-button section is simultaneously moved out of the tool holder.

Therefore, simply inserting the tool tip into the tool holder causes the latching element to be transferred from its latched position to its release position. In other words, the inserted tool tip moves (e.g., pushes/slides/displaces) the push-button section out of the tool holder, thereby transferring the latching element to its release position. A pivot motion or torsion of the tool tip is then no longer necessary.

It is then advantageous to have the cover element and/or the push-button section comprise insertion bevels that facilitate the penetration of the tool tip into the region between the push-button section and the cover element.

According to a further embodiment, the housing can be configured in several parts, where a first housing part comprises the latching element. A second housing part can be configured as a protective sleeve surrounding the first housing part, where the protective sleeve comprises the cover element. The protective sleeve can be made of, for example, metal or plastic material and thus provide the cover element with the necessary stability. The first housing part can in turn be configured as a base body made of plastic material that fills the protective sleeve at least in part.

Optionally, the protective sleeve can comprise an insertion opening that leads or opens to the access channel from outside the housing. This means that the tool tip must be inserted through the insertion opening into the access channel so that the size of the insertion opening defines the type of tools with which the latching engagement can be released.

According to a further embodiment, the protective sleeve can be held at the base body so as to be slidable relative to the latching element. In particular, the protective sleeve can be configured to be movable to a securing position when the latching element is in the latched position, where the protective sleeve in the securing position blocks a motion of the latching element from the latched position to the release position. This means that the protective sleeve fulfills a securing function at the latching engagement between the connector and the mating connector. In other words, the protective sleeve can serve as a connector position assurance (CPA).

The above-mentioned straight-lined configuration of the access channel can be implemented in a particularly simple manner if the protective sleeve together with other parts besides the cover element also delimits the access channel at least in sections, in particular radially outwardly. This means that the protective sleeve can form, for example, an inner wall of the access channel. In particular, the protective sleeve can form a guide surface for the tool tip in the access channel. The guide surface can be oriented radially inwardly spaced from the cover element, and/or be arranged flush with the push-button section. Furthermore, the guide surface can be flush with the push-button section in the plugging direction so that the tool tip is guided by the guide surface into the tool holder and is then also correctly aligned.

In order for the latching element to be better engageable with the mating connector, it is advisable to arrange the latching element on an attachment of the first housing part. The attachment can be elevated transversely, in particular perpendicularly, to the plugging direction. The latching element can be arranged, for example, attached on the attachment.

A simple motion sequence of the latching element arises if the latching element is arranged on the base body such that it can pivot about a pivot axis running perpendicularly to the plugging direction. In this case, the latching element can be configured as a rocker attached to the attachment of the first housing part. For example, the latching element is connected to the attachment of the first housing part by way of a torsion joint.

In the release position, the latching element can be elastically deflected. An elastic restoring force, for example, from the torsion joint, can force the latching element back to the latched position. The latched position, in turn, represents a force-free state of the latching element. Therefore, the latching element, together with the cover element, can form a clamp for retaining the tool tip. In particular, the clamp can be configured to support the dead weight of the entire tool. In other words, the housing can be configured to retain the tool tip inserted into the access channel, along with the remainder of the tool, by clamping it in place. For example, the abutment surface and the push-button section can clamp the tool tip in a frictionally engaged manner.

Clamping the tool tip is helpful when the latching only needs to be released briefly, for example, during maintenance work, in order to re-engage the connector and mating connector after a visual inspection of the interface.

In addition, clamping the tool tip is also useful when the housing has a further latching element. The further latching element can comprise an engagement section and an operating section connected to the engagement section in a motion-transmitting manner, where the engagement section is configured to enter into a further latching engagement with the mating connector, and where the operating section is configured to be pressed by a human finger to release the further latching engagement. In this embodiment, the latching engagement can first be released using the tool tip. The further latching engagement can then be released while the tool, clamped by its tool tip, is retained in place by the housing. In other words, the operating staff does not have to hold the tool in their hand and thus has both hands free to release the further latching engagement.

In this embodiment, the latching elements, i.e., the latching element and the further latching element, represent redundancy, thus increasing reliability. At the same time, safety also increases, since the latching engagements of the latching elements has to be released using different measures. The latching elements can be positioned opposite each other transverse to the plugging direction with respect to the housing, in particular with respect to the first housing part. Consequently, the probability of an accidental release is reduced.

A connector with a housing according to one of the preceding embodiments and with at least one contact element also achieves the object outlined at the outset. The housing, in particular the base body, comprises at least one contact chamber in which the at least one contact element is received.

Such a connector benefits from the advantages of the housing already explained and therefore exhibits increased safety and reliability.

The object outlined above is also achieved by a connection assembly comprising a connector and a mating connector that can be plugged into the connector in the plugging direction. The mating connector comprises at least one mating contact for the at least one contact element of the connector, where the mating connector is configured to enter into latching engagement with the latching element of the connector.

The previously explained advantages of the housing also apply to the connection assembly. In particular, the clear definition of which measures can and cannot be used to release the latching engagement increases the safety and reliability of the connection assembly.

Finally, the subject matter herein also relates to a method for releasing a latching engagement in the connection assembly. The method comprises the steps of inserting the tool tip into the access channel in the plugging direction up to between the push-button section and the cover element, and operating the push-button section using the tool tip. A wedge-shaped tool tip can be pressed between the cover element and the push-button section so that the push-button section is pushed away from the cover element in the triggering direction and is operated. Therefore, simply inserting the tool tip into the access channel can release the latching engagement.

Alternatively, the entire tool can be used as a lever so that the tool tip is pressed against the push-button section. As already described, operating the push-button section moves the latching element from its latched position to its release position.

Optionally, a flat tool tip with one or more flat sides can be used. The width of the flat sides, measured transverse to the tool shank, should be greater than the distance between the cover element and the push-button section when the latching element is in its latched position. Furthermore, the width of the flat sides should correspond to the distance between the cover element and the push-button section when the latching element is in its release position. This allows the flat tool tip to initially be inserted with its flat sides parallel to the abutment surface between the cover element and the push-button section.

The flat tool tip can thereafter be rotated about a longitudinal tool axis that is parallel to the tool shank. For example, the flat tool tip can be rotated by an angle of 45° to 135°, in particular 90°, and thus brought to an upright position. This spreads the cover element and the push-button section apart so that the latching element is moved from its latched position to the release position. This also releases the latching engagement.

### BRIEF DESCRIPTION OF THE DRAWINGS

The invention shall be explained hereafter in more detail with reference to the drawings on the basis of several embodiments, the different features of which may be combined with one another as required in accordance with the above observations, where:

FIG. 1 is a schematic perspective illustration of a connection assembly according to an exemplary embodiment;

FIG. 2 is a further illustration of the connection assembly from FIG. 1;

FIG. 3 is a further illustration of the connection assembly from FIG. 1 with a tool tip inserted;

FIG. 4 shows a detailed view of FIG. 3;

FIG. 5 is a schematic sectional view of a housing according to an exemplary embodiment;

FIG. 6 shows a further illustration of the housing from FIG. 5 with the tool tip not yet inserted; and

FIG. 7 is a further illustration of the housing from FIG. 6 with the tool tip inserted.

### DETAILED DESCRIPTION OF THE INVENTION

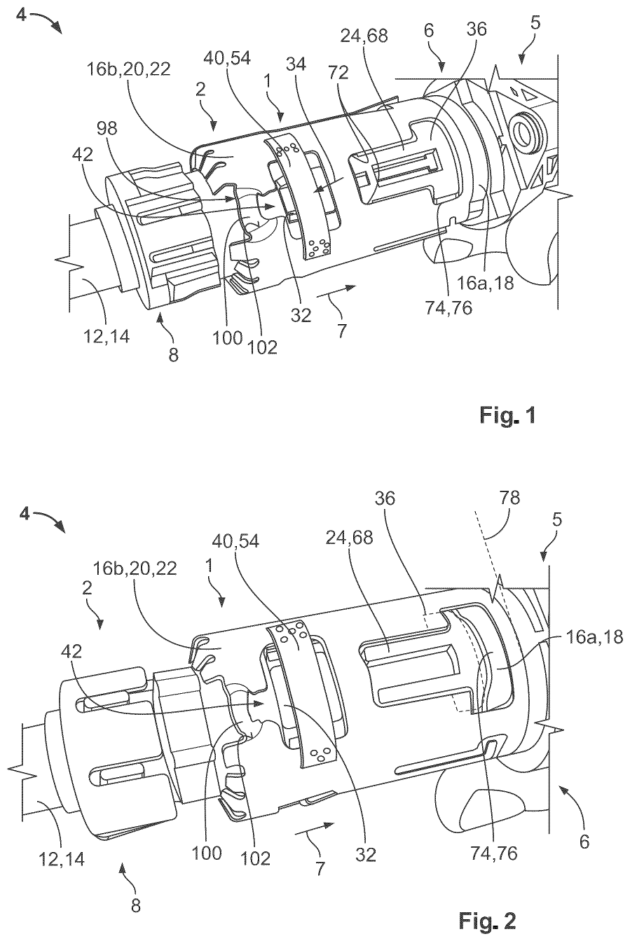

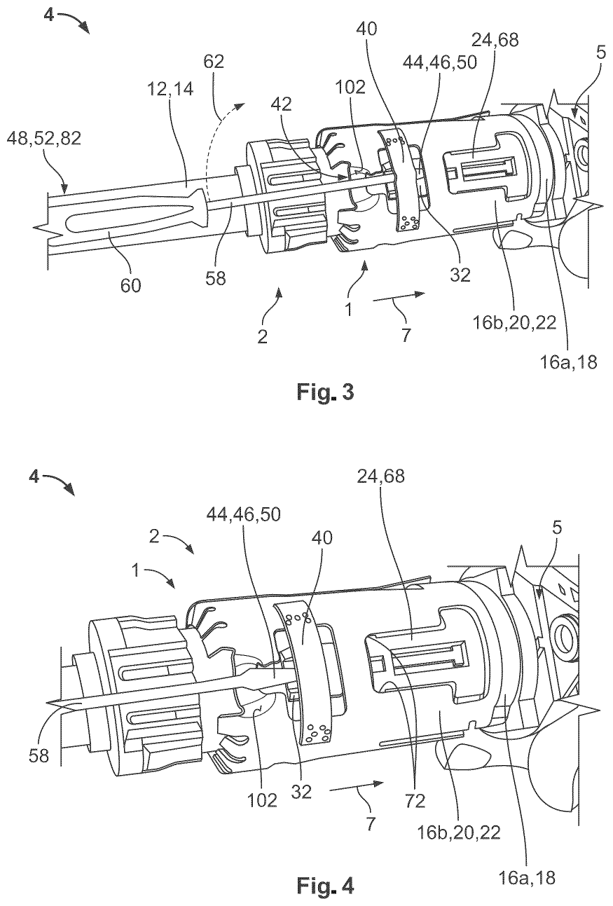

The schematic structure of a housing 1, an electrical connector 2, as well as a connection assembly 4 shall be explained below with reference to FIGS. 1 to 7.

FIG. 1 shows an exemplary embodiment of the connection assembly 4 composed of connector 2 and a mating connector 5. Connector 2 is plugged together with mating connector 5 along a plugging direction 7. Contact elements (not shown) of connector 2 are electrically contacted with mating contacts (not shown) of mating connector 5 for power and/or signal transmission.

Connector 2 comprises housing 1 which can comprise a mating face side 6 pointing in plugging direction 7 and a cable outlet side 8 arranged in plugging direction 7 with respect to housing 1 opposite mating face side 6.

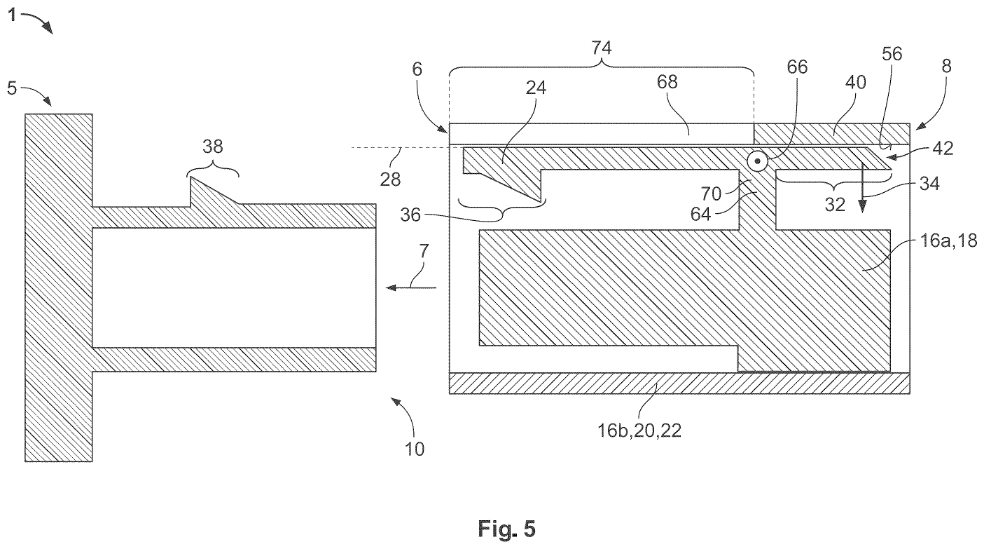

Mating face side 6 preferably has a shape that is complementary to mating face 10 (see FIG. 5) of mating connector 5 and forms an interface, for example, according to an industry standard. The contact elements for the mating contacts are arranged to be accessible in the interface.

The cable outlet side 8 preferably forms a point at which an electrical conductor 12, for example, a cable 14 or wire (not shown), can exit housing 1. Electrical conductor 12 leads to the contact elements in the interface.

In the embodiment shown, housing 1 is configured in several parts. A first housing part 16a can be configured as a base body 18 made of plastic material. A second housing part 16b can be configured as a protective sleeve 20 surrounding first housing part 16a. Protective sleeve 20 can be made, for example, of metal or plastic material. In particular, protective sleeve 20 can be a hollow body 22 with a substantially cylindrical outer shape. Alternatively, the outer shape of hollow body 22 can also be square, cuboid, or polygonal. Base body 18 fills protective sleeve 20 at least in part.

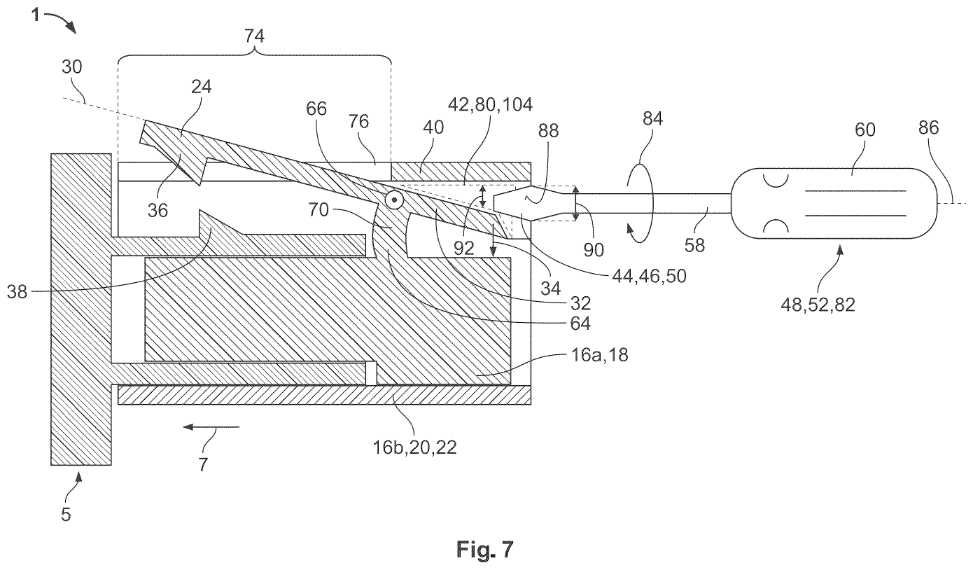

As can be seen in FIG. 5, housing 1 comprises a latching element 24 which is configured to be movable between a latched position 28 and a release position 30 (see FIG. 7) for releasably latching 26 to mating connector 5.

Latching element 24 comprises a push-button section 32 which is configured to be operated in a triggering direction 34. Triggering direction 34 of push-button section 32 can be transverse, in particular perpendicular, to plugging direction 34. Operation of push-button section 32 releases latching engagement 26. Furthermore, latching element 24 has an engagement section 36 which is connected to push-button section 32 in a motion-transmitting manner. Engagement section 36 and push-button section 32 can be connected to one another in one piece that is to say integrally.

Engagement section 36 is configured to be, for example, hook-shaped and enters in a latching connection 35 with a latching section 38 of mating connector 5 when latching element 24 is disposed in latched position 28. This creates latching engagement 26. In release position 30 of latching element 24, engagement section 36 leaves latching connection 35 so that latching engagement 26 is released. In other words, latching element 24 is configured in its latched position 28 to form latching connection 35 with mating connector 5, where latching connection 35 is released in release position 30 of latching element 24.

The operation of push-button section 32 causes latching element 24 to move from latched position 28 to release position 30, whereby latching engagement 26 is released. In this case, the operation of push-button section 32 should only be possible under controlled conditions. This is achieved by housing 1 comprising a cover element 40 that covers push-button section 32 at least in part in triggering direction 34. Cover element 40 can cover push-button section 32 transversely, in particular perpendicularly, to plugging direction 7. Preferably, cover element 40 covers push-button section 32 from the outside of housing 1. This restricts accessibility to push-button section 32. In particular, it can be prevented that push-button section 32 is accidentally operated using the finger or other body parts. Furthermore, damage to push-button section 32 can be prevented.

To nevertheless enable the operation of push-button section 32, an access channel 42 accessible from the outside of housing 1 for inserting a tool tip 44 extends between push-button section 32 and cover element 40. Tool tip 44 can be, in particular, a working tip 46 of a predefined tool 48, for example, a geometrically predetermined blade tip 50 of a screwdriver 52.

Access channel 42 can be configured to be accessible in plugging direction 7 and/or extend in a straight line along plugging direction 7 in a manner matching the elongate shape of tool tip 44. Furthermore, access channel 42 can be arranged on cable outlet side 8 and/or be configured to be accessible from cable outlet side 8.

As can be seen in FIG. 1, protective sleeve 20 can comprise cover element 40. In particular, cover element 40 can be configured as a belt-like material strip 54 that is curved around push-button section 32. Material strip 54 can be an integral part of hollow body 22 or subsequently attached to hollow body 22 by welding or stamping.

Furthermore, cover element 40 can form an abutment surface 56 opposite push-button section 32 for supporting tool tip 44 disposed between push-button section 32 and cover element 40. Abutment surface 56 makes it easier to actuate push-button section 32 with tool tip 44 and thereby to move latching element 24 to release position 30. Because tool tip 44 can be applied onto abutment surface 56 to lever latching element 24 to release position 30 (see FIG. 7). Abutment surface 56 can there form a pivot point from which tool tip 44 extends towards push-button section 32 and from which the remainder of the tool (for example, tool shank 58 and tool handle 60) faces away from push-button section 32. Due to a pivot motion 62 of tool handle 60, tool tip 44 can be pressed onto push-button section 32 in triggering direction 34. This operates push-button section 32 and releases latching engagement 26.

First housing part 16a, in particular base body 18, can comprise latching element 24. In order for latching element 24 to be better engageable with latching section 38 of mating connector 5, it is advisable to arrange latching element 24 on an attachment 64 of first housing part 16a. Attachment 64 can be elevated transversely, in particular perpendicularly to plugging direction 7. Latching element 24 can be arranged, for example, be attached onto attachment 64.

As is evident from FIGS. 5 to 7, latching element 24 can be arranged at base body 18 so as to be pivotable about a pivot axis 66 running perpendicular to plugging direction 7. Latching element 24 can there be configured as a rocker 68 attached to attachment 64 of first housing part 16a. For example, latching element 24 is connected to attachment 64 of first housing part 16a by way of an integral hinge 70 or a torsion joint 72.

FIG. 7 shows that engagement section 36 of latching element 24 in release position 30 can be deflected away from latching section 38 of mating connector 5. Protective sleeve 20 can form an evasion region 74 into which deflected engagement section 36 can move at least in part. Evasion region 74 can be implemented, for example, as a window-like cutout 76 or a bulge (not shown) extending outwardly.

As a comparison of FIGS. 1 and 2 shows, protective sleeve 20 can be held at base body 18 so as to be slidable relative to latching element 24. In particular, protective sleeve 20 can be configured to be movable to a securing position 78 when latching element 24 is in latched position 28. Protective sleeve 20 disposed in securing position 78 then blocks a motion of latching element 24 from latched position 28 to release position 30. The blocking occurs in that, for example, evasion region 74 is slid relative to latching element 24 when protective sleeve 20 is in securing position 78. In particular, engagement section 36 moving into evasion region 74 is then not possible. Consequently, engagement section 36 cannot be deflected and latching element 24 remains in latched position 28.

The region between push-button section 32 and cover element 40 can form a tool holder 80 for receiving tool tip 44. In particular, push-button section 32 and cover element 40 form access channel 42 at least in sections, at the end of which tool holder 80 is formed.

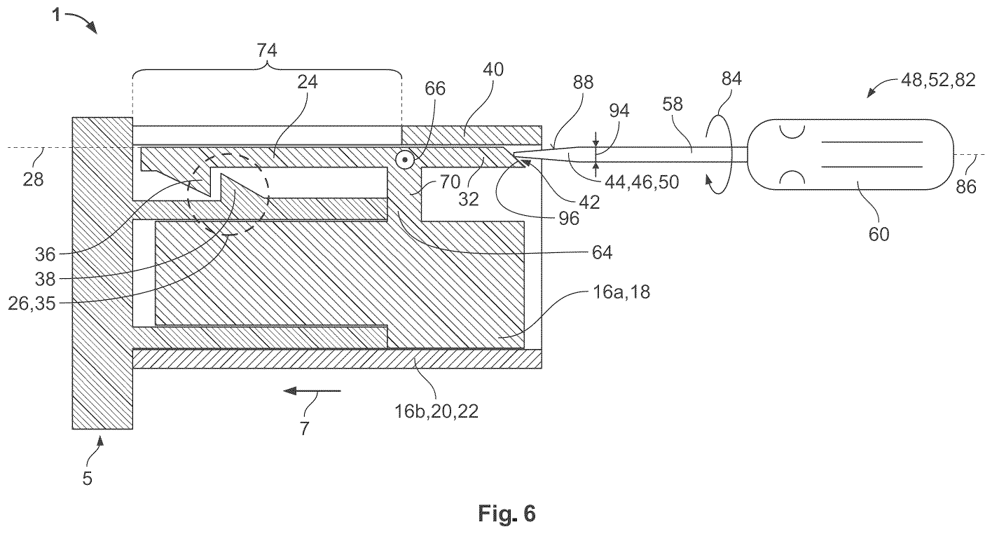

Abutment surface 56 of cover element 40 can extend at least in sections parallel to push-button section 32 when latching element 24 is in latched position 28 (see FIG. 6). When latching element 24 is in release position 30, abutment surface 56 can extend at an angle to push-button section 32 so that tool holder 80 is wedge-shaped (see FIG. 7).

If sufficient pivot motion 62 of tool handle 60 is not possible due to space constraints, a further embodiment can be used in which the access channel is configured to be non-rotationally symmetrical with respect to plugging direction 7, at least in the region between push-button section 32 and cover element 40. This means that a cross-section of this region of access channel 42, in particular of tool holder 80 perpendicular to insertion direction 7 is non-circular. For example, this region of access channel 42, in particular of tool holder 80, can have a rectangular cross-section perpendicular to plugging direction 7.

If, as shown in FIG. 6, a flat, non-rotationally symmetrical tool tip 44 (for example, a slotted screwdriver 82) is inserted into tool holder 80, tool holder 80 can then be spread open thereafter by a rotational motion 84 of tool tip 44 about a tool longitudinal axis 86. This, in turn, operates push-button section 32 in triggering direction 34. In other words, latching element 24 can be levered to release position 30 by torsion of tool tip 44.

Flat tool tip 44 should have one or more flat sides 88. A width 90 (see FIG. 7) of flat sides 88, measured transverse to tool shank 58, should be greater than distance 92 (see FIG. 6) between cover element 40 and push-button section 32 when latching element 24 is in its latched position 28. Furthermore, width 90 of flat sides 88 should correspond to distance 92 (see FIG. 7) between cover element 40 and push-button section 32 when latching element 24 is in its release position 30. Thus, flat tool tip 44 can first be inserted with its flat sides 88 parallel to abutment surface 56 between cover element 40 and push-button section 32 (see FIG. 6).

Flat tool tip 44 can thereafter be rotated about tool longitudinal axis 86 that is parallel to tool shank 58. For example, flat tool tip 44 can be rotated by an angle of 45° to 135°, in particular 90°, and thus brought to an upright position, as shown in FIG. 7. This spreads cover element 40 and push-button section 32 apart, so that latching element 24 is moved from its latched position 28 to release position 30. This releases latching engagement 26.

Optionally, the region between push-button section 32 and cover element 40, in particular tool holder 80, is narrower than a thickness 94 of tool tip 44 when latching element 24 is in latched position 28. In other words, when latching element 24 is in latched position 28, distance 92 between push-button section 32 and cover element 40 is smaller than thickness 94 of tool tip 44. For example, push-button section 32 can occupy tool holder 80 when latching element 24 is in latched position 28. This means that push-button section 32 fills tool holder 80 such that tool tip 44 can be inserted there only if push-button section 32 is simultaneously moved out of tool holder 80.

Therefore, simply inserting tool tip 44 into tool holder 80 causes latching element 24 to be transferred from its latched position 28 to its release position 30. In other words, inserted tool tip 44 moves (e.g., pushes/slides/displaces) push-button section 32 out of tool holder 80, thereby transferring latching element 24 to its release position. A pivot motion 62 or rotational motion 84 of tool tip 44 is then no longer necessary.

It is then advantageous to have cover element 40 and/or push-button section 32 comprise insertion bevels 98 that facilitate the penetration of tool tip 44 into the region between push-button section 32 and cover element. 40

As shown in FIG. 1, protective sleeve 20 can have an insertion opening 98 that leads or opens into access channel 42 from the outside of housing 1. This means that tool tip 44 must be inserted through insertion opening 98 into access channel 42 such that the size of insertion opening 98 defines the type of tools with which latching engagement 26 can be released.

As can also be seen from FIG. 1, protective sleeve 20 can delimit access channel 42 at least in sections, in particular radially outwardly. This means that protective sleeve 20 can form, for example, an inner wall 100 of access channel 42. In particular, protective sleeve 20 can form a guide surface 102 for tool tip 44 in access channel 44.

Guide surface 102 can be oriented radially inwardly, spaced from cover element 40, and/or arranged flush with push-button section 32. Furthermore, guide surface 102 can be flush with push-button section 32 in plugging direction 7 so that tool tip 44 is guided by guide surface 102 into tool holder 80 and is there also correctly aligned.

As shown in FIG. 7, latching element 24 can be elastically deflected in release position 30. An elastic restoring force, for example, from integral hinge 70 or torsion joint 72, can force latching element 24 back to latched position 28. Latched position 28, in turn, represents a force-free state of latching element 24.

Therefore, latching element 24 together with cover element 40 can form a clamp 104 for retaining tool tip 44. In other words, housing 1 can be configured to retain tool tip 44 inserted into access channel 42 by clamping it in place. For example, abutment surface 56 and push-button section 32 can clamp tool tip 44 in a frictionally engaged manner.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed is:

1. Housing for a connector that can be plugged together with a mating connector along a plugging direction, said housing comprising:
a latching element
the latching element is configured to be movable between a release position and a latched position for a releasable latching engagement with said mating connector, and
the latching element comprises a push-button section that can be operated in a triggering direction, upon the operation of which said latching engagement is released,
the latching element comprising a cover element that covers said push-button section at least partly in said triggering direction,
wherein an access channel is accessible from outside said housing for inserting a tool tip extends between said push-button section and said cover element.

2. Housing according to claim 1, wherein said access channel extends in a straight-lined manner along said plugging direction.

3. Housing according to claim 1, wherein said housing comprises a mating face side and a cable outlet side, wherein said access channel is configured to be accessible from said cable outlet side.

4. Housing according to claim 1, wherein said cover element forms an abutment surface disposed opposite said push-button section for supporting said tool tip that is disposed between said push-button section and said cover element.

5. Housing according to claim 1, wherein said access channel is configured to be non-rotationally symmetrical at least in the region between said push-button section and said cover element.

6. Housing according to claim 1, wherein said housing is configured in several parts, wherein a first housing part comprises said latching element and a second housing part is configured as a protective sleeve surrounding said first housing part, wherein said protective sleeve comprises said cover element.

7. Housing according to claim 6, wherein said protective sleeve delimits said access channel at least in sections.

8. Housing according to claim 6, wherein said protective sleeve forms a guide surface for said tool tip, wherein said guide surface is spaced from said cover element and arranged flush with said push-button section.

9. Housing according to claim 6, wherein said first housing part comprises an attachment on which said latching element is disposed.

10. Housing according to claim 6, wherein said latching element is arranged at said first housing part so as to be pivotable.

11. Housing according to claim 1, wherein said latching element is elastically deflected in said release position and together with said cover element forms a clamp for retaining said tool tip.

12. Housing according to claim 1, wherein said housing comprises a further latching element, said further latching element comprising
an engagement section and
an operating section connected to said engagement section in a motion-transmitting manner,
wherein said engagement section is configured to enter into a further latching engagement with said mating connector, wherein said operating section is configured to be pressed by a human finger to release said further latching engagement.

13. Connection assembly for a connector that can be plugged together with a mating connector along a plugging direction, the connector comprising:
a housing comprising a latching element, the latching element is configured to be movable between a release position and a latched position for a releasable latching engagement with said mating connector, the latching element comprises a push-button section that can be operated in a triggering direction, upon the operation of which said latching engagement is released, the latching element comprising a cover element that covers said push-button section at least partly in said triggering direction, wherein an access channel is accessible from outside said housing for inserting a tool tip extends between said push-button section and said cover element; and
at least one contact element, wherein said housing comprises at least one contact chamber in which said at least one contact element is received.

14. Connection assembly according to claim 13, wherein the mating connector is configured to be plugged together with said connector in said plugging direction, wherein said mating connector comprises at least one mating contact for said at least one contact element of said connector, wherein said mating connector is configured to enter into said latching engagement with said latching element of said connector.

15. Method for releasing a latching engagement in a connection assembly, the connector assembly including a housing for a connector that can be plugged together with a mating connector along a plugging direction, the housing including a latching element configured to be movable between a release position and a latched position for a releasable latching engagement with said mating connector, the latching element comprises a push-button section that can be operated in a triggering direction, upon the operation of which said latching engagement is released, the latching element comprising a cover element that covers said push-button section at least partly in said triggering direction, wherein an access channel is accessible from outside said housing,
the method comprising the steps of:
inserting a tool tip into said access channel in said plugging direction up to between said push-button section and said cover element, and
operating said push-button section using said tool tip.
